(19) United States
(12) Patent Application Publication
(10) Pub. No.: US 2008/0156527 A1
(43) Pub. Date: Jul. 3, 2008

(54) ACTIVE CABLE RESTORATION HARNESS

(75) Inventor: Noah Crawford, Key West, FL (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/617,415

(22) Filed: Dec. 28, 2006

(51) Int. Cl. H01B 7/00

(52) U.S. Cl. 174/72 A

(57) ABSTRACT

A cable restoration harness is provided for splicing wires of an active cable for communicating a telecommunications service without causing an interruption in the service. The harness may include two splice modules connected by a set of harness wires. The harness may be connected to the cable to create a half-tap splice such that a telecommunications service carried by the cable is routed over the harness wires and around damaged wiring by making an electrical connection of the harness wires between the top of a first splice module and the bottom of a second splice module or by making an electrical connection of the harness wires between the tops of both splice modules.

### BACKGROUND

In the telecommunications industry, field technicians utilize a cable restoration harness to “cutover” or switch circuits being carried by the wires of one cable to another cable. Typically, cable restoration harnesses consist of splicing modules designed to splice corresponding pairs of wires in two cables. A typical three layer splicing module usually includes a base member or index strip, a body member, and a cover member or cap. The body member consists of upper and lower segments to capture contact elements and the segments are welded together. The harness includes splice wires placed in grooves in the base and in grooves of the lower segment of each splicing module. Cable wires that are to be spliced or “cutover” are then placed in the upper segments of the splicing modules. The cover is then placed over the upper surface of the upper segment on each splicing module to complete the splice.

While current cable restoration harnesses are useful for splicing cable wires, the splice cuts through existing wiring making the harness unsuitable for cutting around active cable wires carrying a telecommunications service without interrupting the service. Thus, when an active cable is partially cut or damaged resulting in a combination of active wires and inactive wires in the same cable, the entire cable must be taken out of service when splicing with existing harnesses, resulting in customers connected to the active wires being taken out of service. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Various embodiments utilizing the techniques described herein address the above and other problems by providing a cable restoration harness for splicing wires of an active cable for communicating a telecommunications service without causing an interruption in the service. The harness may include two splice modules connected by a set of harness wires. The first splice module may include a body member having conductive contacts for making an electrical connection with wires from the cable and a set of harness wires. The first splice module may also include a cover member or cap having slotted openings in contact with the top of the body member to form a wire junction with the set of harness wires. The first splice module may also include a base member or index strip having wire retaining members for holding the cable wires to be spliced. The index strip is adapted to connect to the bottom of the body member.

The second splice module also includes a body member having conductive contacts for making an electrical connection with the cable wires and the harness wires. The second splice module may also include a base member or index strip which is connected to the bottom of the body member. The index strip has wire retaining members for holding the set of harness wires which are also connected to the first splice module. The second splice module may also include a cover member or cap having slotted openings adapted for connection with the top of the body member to form a wire junction with the cable wires extending from the first splice module.

The cable harness may be utilized to create a three-way or half-half tap splice between damaged wires in the cable, undamaged wires in cable, and the harness wires such that a telecommunications service carried by the cable is routed around the damaged cable wires using the harness wires, without an interruption of service. This may be accomplished by making an electrical connection of the harness wires between the top of the first splice module and the bottom of the second splice module or by making an electrical connection of the harness wires between the tops of both splice modules.

Other systems and/or methods according to various embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a partially exploded view of a cable restoration harness showing connected splicing modules, a base member or index strip, and a cap, in accordance with various embodiments of the invention;

FIG. 2 is a perspective view showing the wires of a telecommunications cable laying on top of the base member or index strip of a splicing module, in accordance with various embodiments of the invention;

FIG. 3 is a perspective view showing a half-tap splice connection created using a cable restoration harness consisting of a fully assembled first splice module spliced to the wires of a telecommunications cable and connected to a partially assembled second splice module, in accordance with various embodiments of the invention;

FIG. 4 is a perspective view showing a cable restoration harness consisting of a fully assembled first splice module and a partially assembled second splice module and showing the wires of a telecommunications cable laying on the top of the body member of the partially assembled second splice module, in accordance with various embodiments of the invention;

FIG. 5 is a perspective view showing a cable restoration harness consisting of a fully assembled first splice module and a partially assembled second splice module and showing the wires of a telecommunications cable crimped onto the top of the body member of the partially assembled second splice module, in accordance with various embodiments of the invention;

FIG. 6 is a perspective view showing a fully assembled cable restoration harness consisting of first and second splice modules and showing a wire cutoff tool for cutting off cable wires extending from the bottom of the first splice module; and

FIG. 7 is a partially exploded view of a cable restoration harness showing connected splicing modules and two base members or index strips, in accordance with various alternative embodiments of the invention.

### DETAILED DESCRIPTION

As briefly described above, embodiments of the present invention are directed to a cable restoration harness for splicing wires of an active cable for communicating a telecommunications service without causing an interruption in the service. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

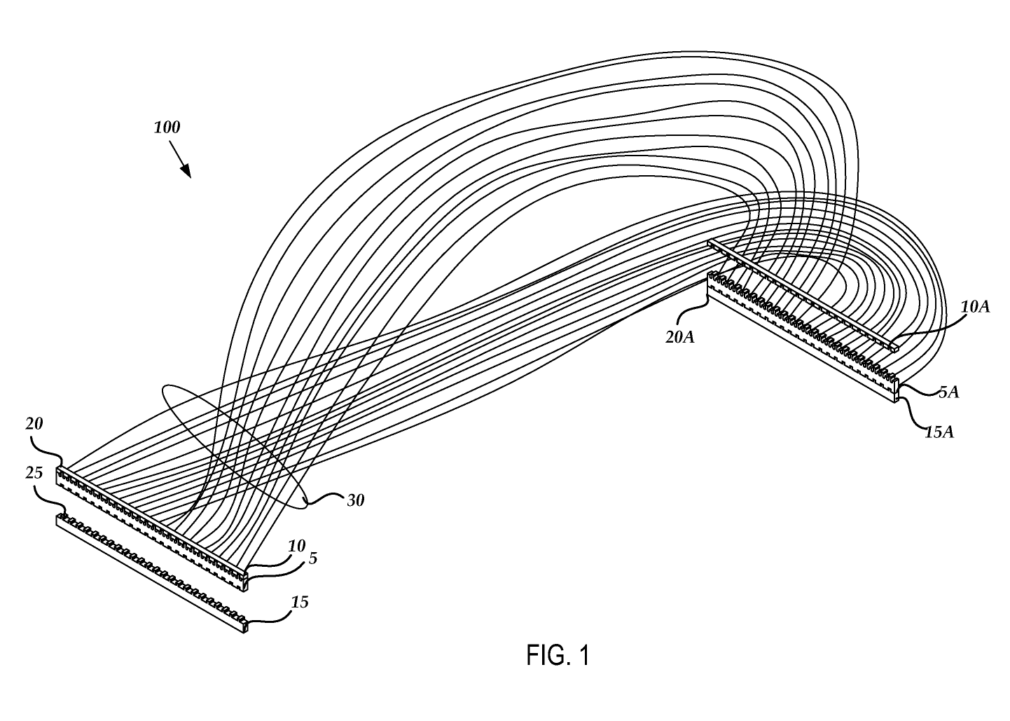

Referring now to the drawings, in which like numerals represent like elements through the several figures, various aspects of the present invention and an illustrative computing operating environment will be described. Referring now to FIG. 1, a partially exploded view of a cable restoration harness 100 in accordance with various embodiments of the invention will be described. As shown in FIG. 1, the cable restoration harness 100 includes a splice module 20 connected to a splice module 20A via harness wires 30. The splice module 20 may consist of a body member 5, a cover member or cap 10, and a base member or index strip 15. The top and bottom surfaces of the body member 5 may consist of conductive contacts adapted to make electrical connections. In particular, the conductive contacts making up the top surface of the body member 5 are in contact and make an electrical connection with the harness wires 30. The cap 10 may include slotted openings which connect the cap 10 to the conductive contacts making up the top surface of the body member 5. The body member 5 also forms a wire junction with the cap 10 for retaining the harness wires 30 which extend from the connection of the cap 10 and the body member 5. The index strip 15 may consist of wire retaining members 25 and is adapted to connect with the bottom surface of the body member 5. The wire retaining members 25 may be utilized for retaining wires to be spliced in a cable.

The splice module 20A may consist of a body member 5A, a cover member or cap 10A, and a base member or index strip 15A. The index strip 15A is connected to the bottom surface of the body member 5A. Similar to the index strip 15, the index strip 15A may also consist of wire retaining members which are utilized to hold the harness wires 30 extending from the splice module 20. The cap 10A includes slotted openings for connection to the conductive contacts making up the top surface of the body member 5A. The cap 10A is also adapted to form a wire junction with the body member 5A for retaining the cable wire to be spliced (not shown).

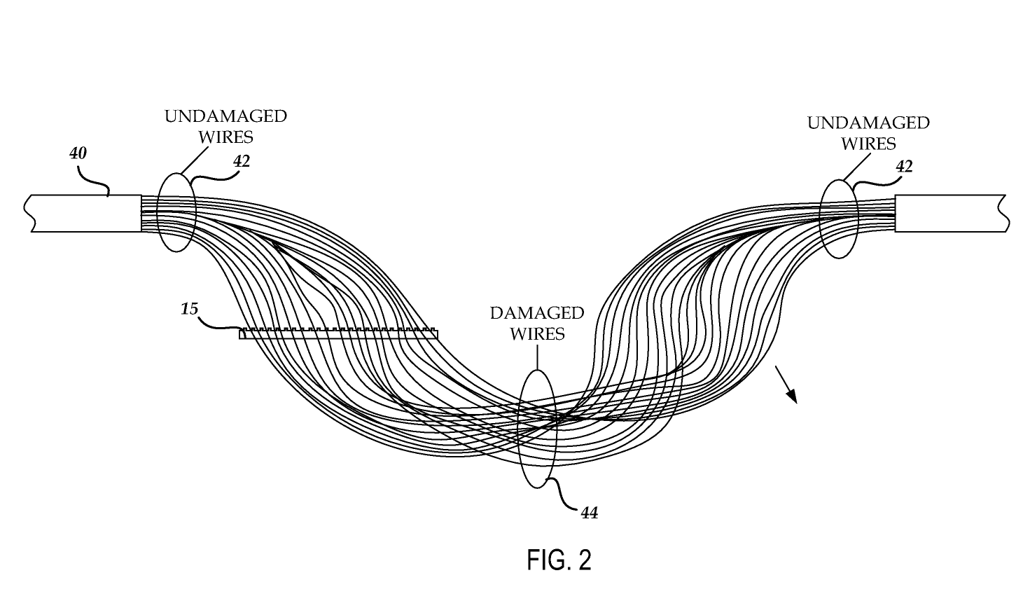

It will be appreciated by those skilled in the art that the cable restoration harness 100 may be constructed using a modified 710 type half-tap splice module which is currently manufactured and marketed by 3M CORPORATION of St. Paul, Minn. It should be understood that the cable restoration harness 100 described herein, and in accordance with various embodiments, may be utilized to splice wires in an active cable carrying a telecommunications service (such as telephone service) without creating a service interruption, as will be discussed in further detail below with respect to FIGS. 2-6.

FIGS. 2-6, discussed below, are illustrative of a method for utilizing the cable restoration harness 100 discussed above with respect to FIG. 1, in accordance with various embodiments, among others, utilizing the technical features described herein. Referring now to FIG. 2, an active cable 40 is shown comprising undamaged wires 42 and damaged wires 44. It should be understood that the active cable 40, according to various embodiments, is being utilized to carry a telecommunications service to one or more customers in a telecommunications network. It should be further understood that the damaged wires 44 represent at least one but not all of wires in the active cable 40. The damaged wires 44 are incapable of carrying the telecommunications service as a result of any number of events including, but not limited to, water damage to the cable or a cable cut. In splicing the active cable 40 using the cable restoration harness 100, the undamaged wires 42 on the left side of the damaged wiring 44, may be placed in the wire retaining members 25 of the index strip 15 to hold the wires.

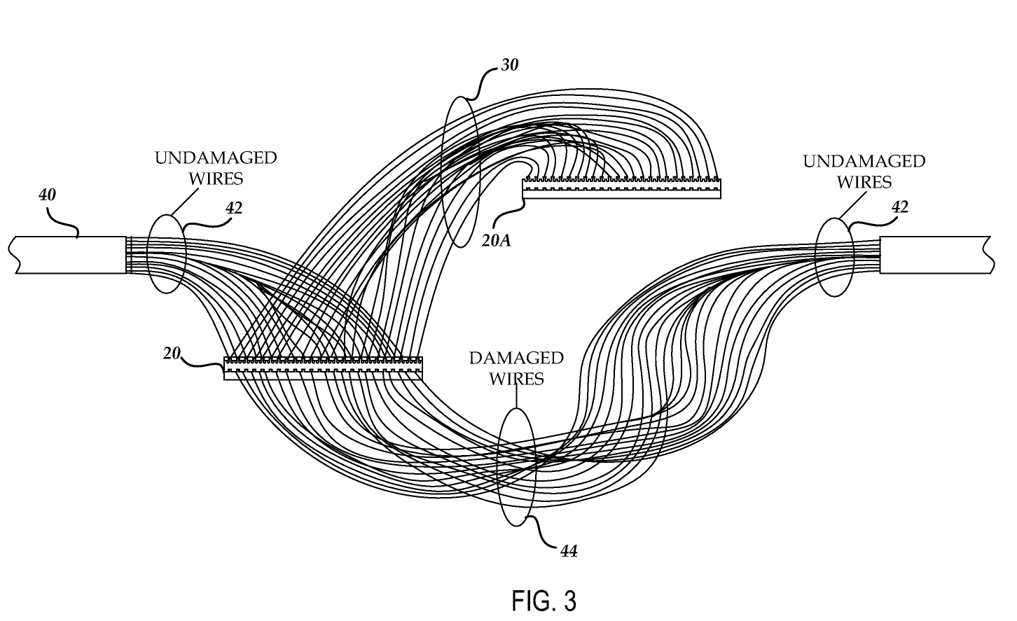

Referring now to FIG. 3, the cable restoration harness 100 is shown with the splice module 20 creating a three-way electrical connection or half-tap between the undamaged wires 42, the harness wires 30, and the damaged wires 44. The half-tap connection may be made by crimping the connected body member 5 and the cap member 10 from the cable restoration harness 100 to the cable wires being retained in the index strip 15. In particular, as the conductive contacts making up the bottom surface of the body member 5 are crimped to the wires being retained by the index strip 15, an electrical connection is established.

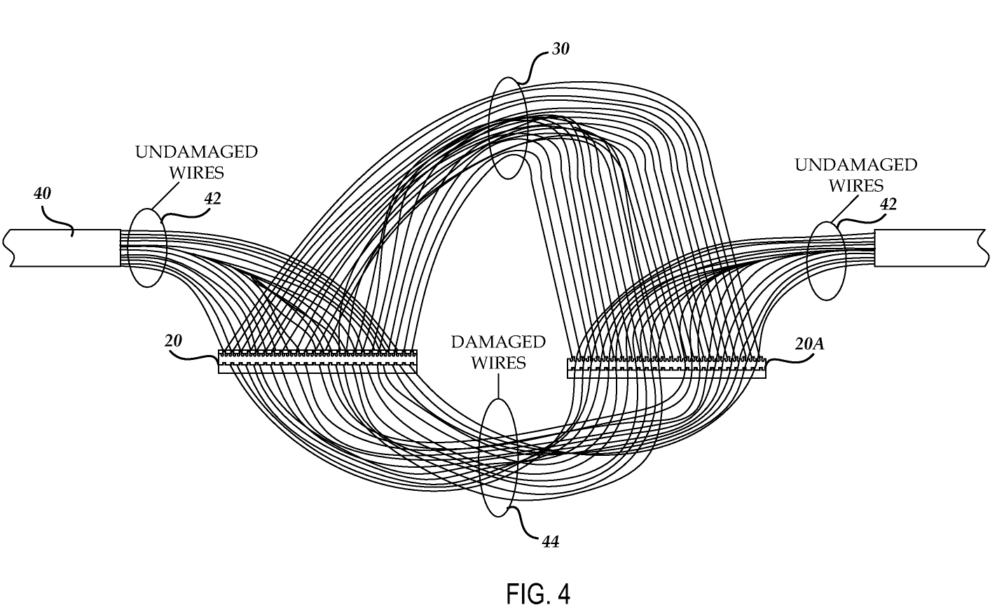

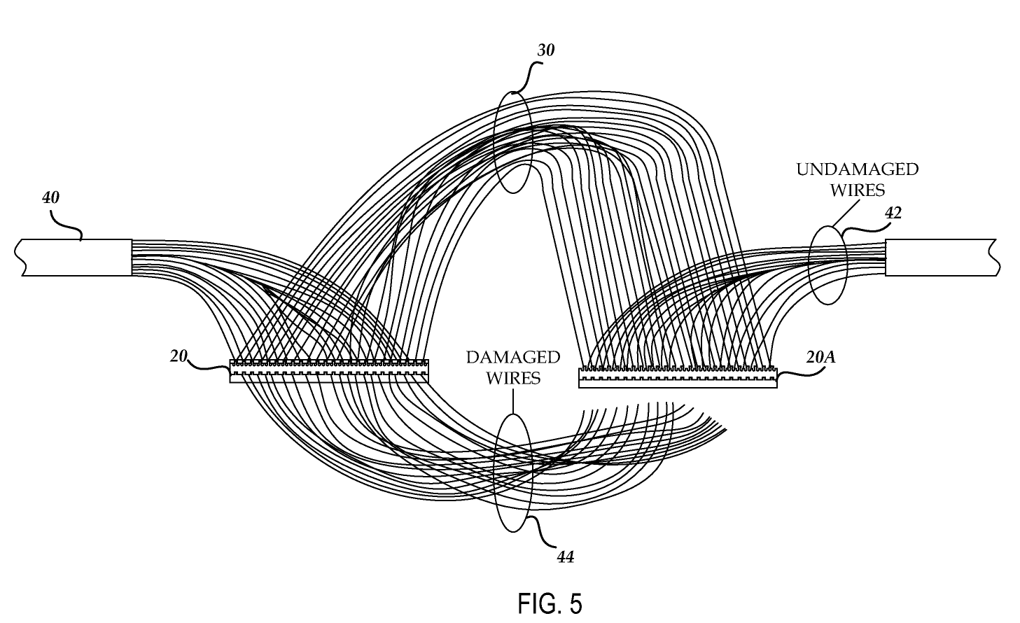

Referring now to FIG. 4, the cable restoration harness 100 is shown with the undamaged wires 42 to the right of the damaged wires 44 placed on the top of the body member 5A of the splice module 20A. As will be discussed in greater detail with respect to FIG. 5, the undamaged wires 42 may be crimped onto the conductive contacts making up the top surface of the body member 5A to make an electrical connection between the undamaged wires 42 and the harness wires 30 in the splice module 20A.

Referring now to FIG. 5, the cable restoration harness 100 is shown with the undamaged wires connected to the top surface of the body member 5A to establish an electrical connection between the harness wires 30 (which may be pre-spliced to the bottom of the splice module 20A) and the undamaged wires 42. The electrical connection may be made by crimping the undamaged wires 42 onto the conductive contacts making up the top surface of the body member 5A in the splice module 20A. It should be understood that as a result of crimping the undamaged wires 42 to the splice module 20A, the damaged wires 44 are cutoff from the splice module 20A.

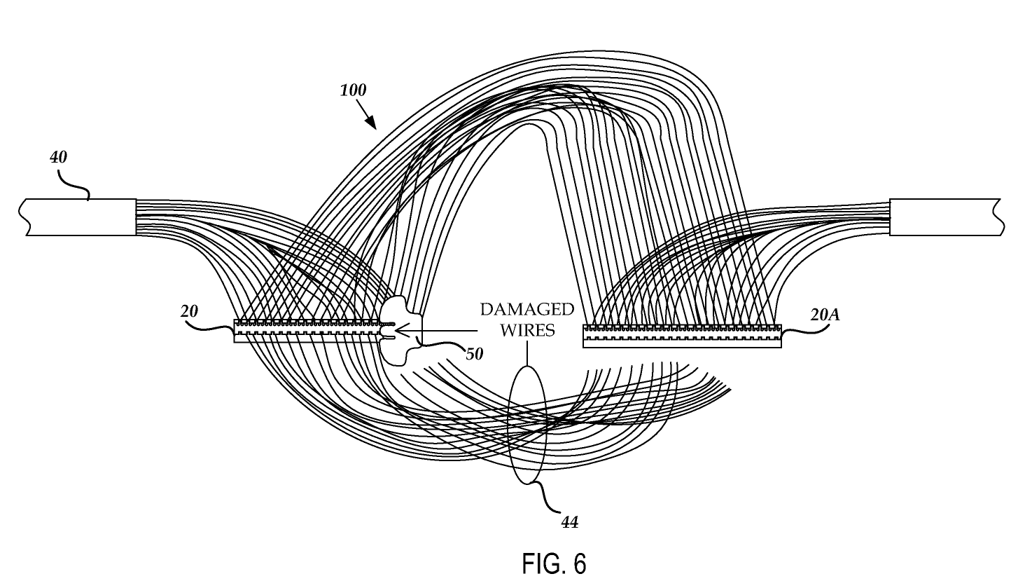

Referring now to FIG. 6, the cable restoration harness 100 is shown with a cap (such as the cap 10A) crimped on top of the body member 5A of the splice module 20A. A wire cutoff tool 50 is also shown attached to the splice module 20. The wire cutoff tool 50 may be utilized to cutoff the other end of the damaged wires 44 from the splice module 20 by pulling the wire cutoff tool 50 across the splice module 20 to trim off the wires.

It should be appreciated that by establishing a half-tap connection in the manner described above with respect to FIGS. 2-6 (i.e., by utilizing the cable harness 100 having the harness wires 30 being connected between the top of the splice module 20 and the bottom of the splice module 20A), a telecommunications service currently being carried by the undamaged wires 42 is not interrupted. Thus, the cable restoration harness 100 enables a technician to cut around damaged wiring without affecting service in an active cable.

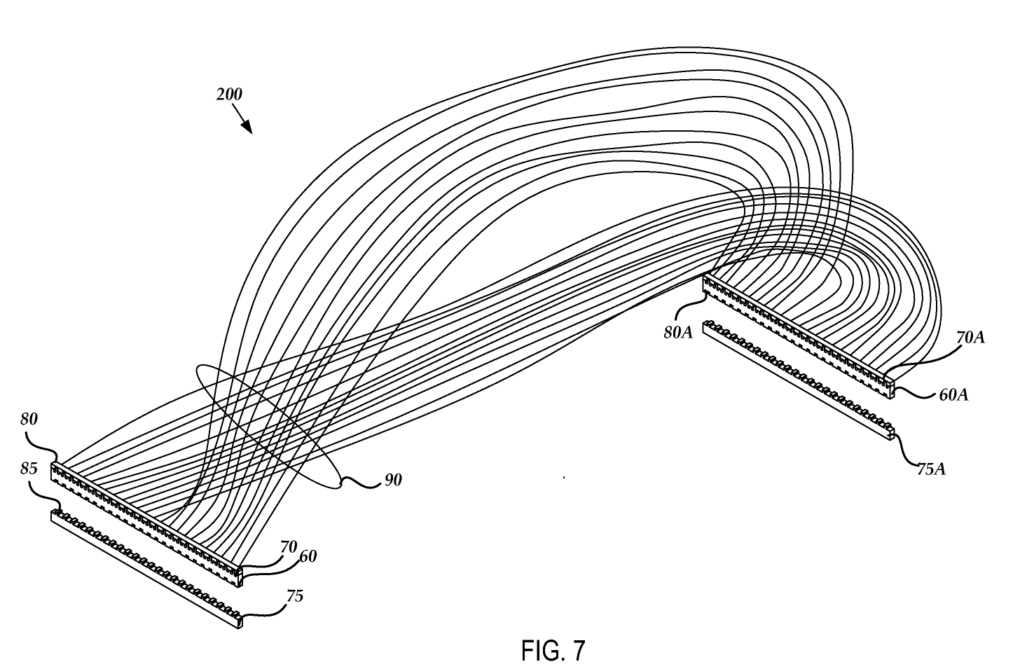

Referring now to FIG. 7, a partially exploded view of a cable restoration harness 200 in accordance with various alternative embodiments of the invention will be described. As shown in FIG. 7, the cable restoration harness 200 includes a splice module 80 connected to a splice module 80A via harness wires 90. The splice module 80 may consist of a body member 60, a cover member or cap 70, and a base member or index strip 75. The top and bottom surfaces of the body member 60 may consist of conductive contacts adapted to make electrical connections. In particular, the conductive contacts making up the top surface of the body member 60 are in contact and make an electrical connection with the harness wires 90. The cap 70 may include slotted openings which connect the cap 70 to the conductive contacts making up the top surface of the body member 60. The body member 60 also forms a wire junction with the cap 70 for retaining the harness wires 90 which extend from the connection of the cap 70 and the body member 60. The index strip 75 may consist of wire retaining members 85 and is adapted to connect with the bottom surface of the body member 60. The wire retaining members 85 may be utilized for retaining wires to be spliced in a cable.

The splice module 80A may consist of a body member 60A, a cover member or cap 70A, and a base member or index strip 75A. The top and bottom surfaces of the body member 60A may consist of conductive contacts adapted to make electrical connections. In particular, the conductive contacts making up the top surface of the body member 60A are in contact and make an electrical connection with the harness wires 90. The cap 70A may include slotted openings which connect the cap 70A to the conductive contacts making up the top surface of the body member 60A. The body member 60A also forms a wire junction with the cap 70A for retaining the harness wires 90 which extend from the connection of the cap 70A and the body member 60A. The index strip 75A may consist of wire retaining members 85A and is adapted to connect with the bottom surface of the body member 60A. The wire retaining members 85A may be utilized for retaining wires to be spliced in a cable. It should be understood that the cable restoration harness 200 may also be utilized to splice wires in an active cable carrying a telecommunications service (such as telephone service) without creating a service interruption by connecting the harness wires 90 between the top surfaces of the body members 60 and 60A in the splice modules 80 and 80A.

Based on the foregoing, it should be appreciated that various embodiments of the present invention are directed to a cable restoration harness for splicing wires of an active cable for communicating a telecommunications service without causing an interruption in the service. It will be apparent by those skilled in the art that various modifications or variations may be made in the present invention without departing from the scope or spirit of the invention. Other embodiments of the present invention will be apparent to those skilled in the art from consideration of the specification and practice of the invention disclosed herein.

1. An apparatus for splicing a first plurality of wires to a second plurality of wires without interrupting a telecommunications service being carried by at least one pair of the second plurality of wires, comprising:
a first body member having top and bottom surfaces, the top and bottom surfaces comprising a plurality of conductive contacts extending there from, the plurality of conductive contacts extending from the top surface making an electrical connection with the first plurality of wires;
a first cover member comprising a plurality of slotted openings in contact with the top surface of the first body member to receive a plurality of protrusions from the top surface of the body member to align the first cover member with the first body member and to form a conductive wire junction therebetween with the first plurality of wires, the first plurality of wires extending from the wire junction;
a first base member comprising a plurality of wire retaining members adapted for connecting with the bottom surface of the first body member and retaining the second plurality of wires, the first base member forming a conductive wire junction with the second plurality of wires when the first base member is crimped against the bottom surface of the first body member;
a second body member having top and bottom surfaces, the top and bottom surfaces comprising a plurality of conductive contacts extending therefrom, the plurality of conductive contacts extending from the top surface making an electrical connection with the second plurality of wires;
a second base member comprising a plurality of wire retaining members connected to the bottom surface of the second body member, the wire retaining members retaining the first plurality of wires extending from the wire junction formed by the first body member and the first cover member, the second base member forming an electrical junction with the first set of wires when crimped against the bottom surface of the second body member; and
a second cover member having a plurality of slotted openings adapted for connection with the top surface of the second body member to form a conductive wire junction therebetween with the second plurality of wires, without interrupting the telecommunications service being carried by the at least one pair of the second plurality of wires.

2. The apparatus of claim 1, wherein the first cover member in contact with the top surface of the first body member and the first base member adapted to make contact with the bottom surface of the first body member are adapted to form a three-way electrical connection between the second plurality of wires extending from a first longitudinal side of the first body member, the second plurality of wires extending from a second longitudinal side of the first body member, and the first plurality of wires extending from the top surface of the first body member when an electrical connection is made with the bottom surface of the first body member.

3. The apparatus of claim 2, wherein the first longitudinal side of the first body member is opposite the second longitudinal side of the first body member.

4. The apparatus of claim 2, wherein at least one pair of the second plurality of wires extending from a second longitudinal side of the bottom surface of the first body member are damaged.

5. The apparatus of claim 4, wherein the second base member is adapted to cutoff the electrical connection with the second plurality of wires extending from the second longitudinal side of the bottom surface of the first body member.

6. The apparatus of claim 1, wherein the three-way electrical connection comprises a half-tap splice.

7. The apparatus of claim 1, wherein the first body member, the first cover member, and the first base member comprise a first splice module.

8. The apparatus of claim 7, wherein the second body member, second cover member, and the second base member comprise a second splice module.

9. The apparatus of claim 8, wherein the first splice module, the first plurality of wires, and the second splice module comprise a wiring harness.

10. The apparatus of claim 1, wherein the second plurality of wires are enclosed in a cable for providing the telecommunications service.

11. A cable restoration harness for splicing a first plurality of wires to a second plurality of wires without interrupting a telecommunications service being carried by at least one pair of the first plurality of wires, comprising:
a first splice module having a first plurality of conductive contacts for making at least one electrical connection with the first plurality of wires,
wherein when the first plurality of wires is crimped against the first plurality of conductive contacts an electrical connection with an undamaged set of wires in the first plurality of wires is established and when the first plurality of wires is crimped against the second plurality of conductive contacts an electrical connection with a damaged set of wires in the first plurality of wires is cut off without interrupting the telecommunications service being carried by the at least one pair of the first plurality of wires.

12. The cable restoration harness of claim 10, wherein the undamaged set of wires in the first plurality of wires connected to the first splice module extend from a first longitudinal side of the first splice module.

13. The cable restoration harness of claim 12, wherein the damaged set of wires in the first plurality of wires extend connected to the first splice module extend from a longitudinal side opposite the first longitudinal side of the first splice module.

14. The cable restoration harness of claim 11, wherein the first splice module comprises a first body member having a top surface and the second splice module comprises a second body member having a bottom surface, wherein the second plurality of wires are connected to the top surface of the first body member and the bottom surface of the second body member.

15. The cable restoration harness of claim 11, wherein the first splice module forms a three-way electrical connection with the damaged set of wires in the first plurality of wires, the undamaged set of wires in the first plurality of wires, and the second plurality of wires, the three-way electrical connection comprising a half-tap splice.

16. A cable restoration harness for splicing a first plurality of wires without interrupting a telecommunications service being carried by at least one pair of the first plurality of wires, comprising:
a first splice module having a first plurality of conductive contacts for making at least one electrical connection with the first plurality of wires; and
a second splice module having a second plurality of conductive contacts for making at least one electrical connection with the first plurality of wires,
wherein when the first plurality of wires is crimped against the first plurality of conductive contacts an electrical connection with an undamaged set of wires in the first plurality of wires is established and when the first plurality of wires is crimped against the second plurality of conductive contacts an electrical connection with a damaged set of wires in the first plurality of wires is cut off without interrupting the telecommunications service being carried by the at least one pair of the first plurality of wires, wherein further the first splice module comprises a first body member having a bottom surface and the second splice module comprises a second body member having a top surface, wherein the second plurality of wires are connected to the bottom surface of the first body member and the top surface of the second body member.

17. The cable restoration harness of claim 16, wherein the undamaged set of wires in the first plurality of wires connected to the first splice module extend from a first longitudinal side of the first splice module.

18. The cable restoration harness of claim 17, wherein the damaged set of wires in the first plurality of wires extend connected to the first splice module extend from a longitudinal side opposite the first longitudinal side of the first splice module.

19. The cable restoration harness of claim 17, wherein the first splice module forms a three-way electrical connection with the damaged set of wires in the first plurality of wires, the undamaged set of wires in the first plurality of wires, and the second plurality of wires.

20. The cable restoration harness of claim 19, wherein the three-way electrical connection comprises a half-tap splice.
